(19) United States
(12) Patent Application Publication
(10) Pub. No.: US 2008/0319799 A1
(43) Pub. Date: Dec. 25, 2008

(54) System and method for storing medical data

(76) Inventor: Kathryn Knowlton, Sherman Oaks, CA (US)

Correspondence Address: SOFER & HAROUN LLP., 317 MADISON AVENUE, SUITE 910, NEW YORK, NY, 10017, US

(21) Appl. No.: 12/150,314

(22) Filed: Apr. 25, 2008

Related U.S. Application Data
(60) Provisional application No. 60/926,240, filed on Apr. 25, 2007.

(51) Int. Cl. G06Q 50/00

(52) U.S. Cl. 705/3

(57) ABSTRACT

A method for uploading of a user's medical data to a portable device includes receiving a request for storage of medical data to a portable device and collecting medical data from a plurality of sources. The data is converted to a uniform format for storage on the portable device. At least one user input is received relating to the organization of the medical data into at least one first emergency layer of data representing a first category of information and at least one second secured layer of data representing a second category of information, where the first and second layers of data are an organized medical data. A communication to the user is generated for uploading their organized medical data to the portable device.

### RELATED APPLICATION

This application claims the benefit of priority from U.S. Provisional Patent Application No. 60/926,240, filed on Apr. 25, 2007, the entirety of which is incorporated by reference.

### FIELD OF THE INVENTION

The present invention is related to the field of medical data. More particularly, the present invention is related to a system and method for portably storing medical data.

### BACKGROUND

In the area of medical data storage there are many instances where fast and easy access to medical personal is highly desirable. For example, in the event of a medical emergency, it may be desirable to have medical data on-hand for use by emergency personal and even later attending physicians. However, most individuals have do not have their medical records readily available.

With storage mediums, such as flash drives, USB (Universal Serial Bus) drives and other such portable storage devices it is now possible to store large quantities of data in a highly portable manner. In fact, many such storage devices are configured into wearable forms including pendants, bracelets key chains, etc. . . . The data stored in these portable devices may include and digitized data such as personal data, work files, and even medical histories and other emergency medical information.

### OBJECTS AND SUMMARY

The present invention looks to overcome the drawbacks associated with the prior art and to provide an easy and convenient manner to place a user's medical records and other essential emergency medical records onto a portable storage device.

Additionally, it is another object of the present invention to provide a layered storage for the medical records so that a first set of medical data is provided with a first level of access and at least one second set of medical data is provided with a second level of access having a heightened security.

To this end, the present invention provides for a method for uploading of a user's medical data to a portable device. The method includes receiving a request for storage of medical data to a portable device and collecting medical data from a plurality of sources.

The data is converted to a uniform format for storage on the portable device. At least one user input is received relating to the organization of the medical data into at least one first emergency layer of data representing a first category of information and at least one second secured layer of data representing a second category of information, where the first and second layers of data are an organized medical data. A communication to the user is generated for uploading their organized medical data to the portable device.

### BRIEF DESCRIPTION OF THE DRAWINGS

The present invention can be best understood through the following description and accompanying drawings, wherein:

FIG. 1 illustrates a portable medical record device in accordance with one embodiment of the present invention;

FIG. 2 illustrates a medical data storage system in accordance with one embodiment of the present invention;

FIG. 3 is a flow chart illustrating a user interface with the medical data storage system of FIG. 2 in accordance with one embodiment of the present invention;

FIG. 4 illustrates a user medical data account record in accordance with one embodiment of the present invention;

FIG. 5 illustrates a user medical data account record in accordance with one embodiment of the present invention;

FIG. 6 is a flow chart showing an update procedure for the device of FIG. 1, in accordance with one embodiment of the present invention; and

FIG. 7 is a flow chart showing an emergency medical personal use of the portable medical record device of FIG. 1, in accordance with one embodiment of the present invention; and

### DETAILED DESCRIPTION OF THE INVENTION

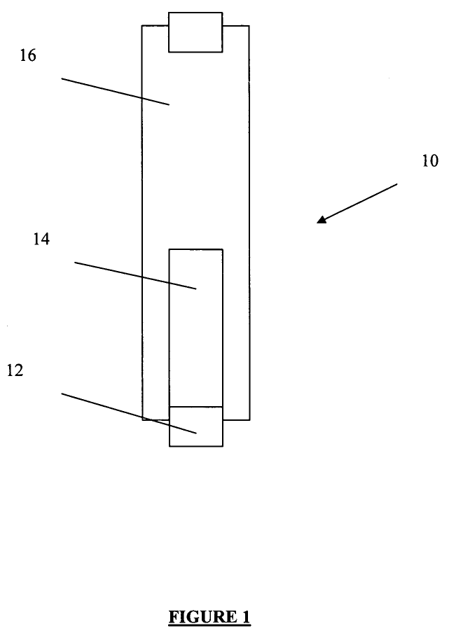

In one embodiment of the present invention, as illustrated in FIG. 1, a portable digital storage device 10 is shown for storing a user's medical records as discussed in more detail below.

As illustrated, device 10 is a in the form of a wearable flash drive (USB drive Universal Serial Bus) having an interface 12 and storage portion 14 and a wearable element 16, such as wrist band. For the purposes of illustrating the salient features of the present invention, device 10 is discussed throughout as a wearable device as shown in FIG. 1. However, it is understood that any small portable digital storage medium, such as flash memory cards/chips, portable drives and other such item may be used in conjunction with the features of the present invention. Moreover, such devices may be wearable as shown in FIG. 1, or may be in other formats such as a card for storage within a wallet or purse.

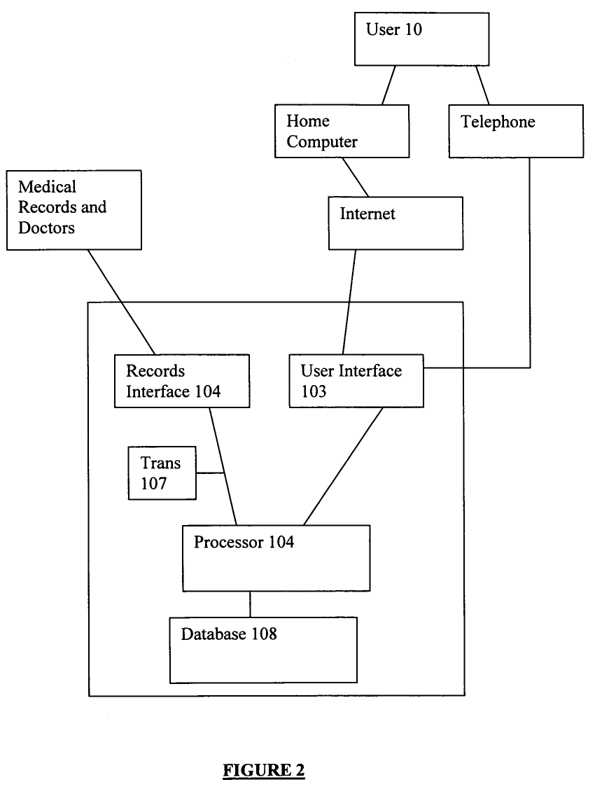

Turning to the collection and organization of the user's medical data, FIG. 2 is a diagram of the various components of a medical data storage system 100 configured to collect, store, organize and upload the users medical data to their storage device 10.

As shown in FIG. 2, a user 102 may interface with system 100 via the internet or traditional telephone lines, using a desktop or laptop computer, telephone or any wireless communication device either by SMS, e-mail, voice, HTML, or other communication formats.

System 100 is advantageously configured as a plurality of web enabled servers, either together or remotely located from one another, to support typical web functions including interfacing with users 102.

An interface module 103 is configured to receive incoming communications from user 102. As shown in FIG. 2, such communications may be in the form of web/internet communications or they may be incoming telephone calls. It is contemplated that interface 103 supports both typical GUI (Graphic User Interfaces) for two-way web communications as well as automated-live operator support for telephone customers 102 or in the event of help calls from web users 102. User interface module 103 is also configured to support upload operations to the computing device of user 102 in order to place the organized medical records onto their device 10 as explained below.

Operations platform processor 104 of system 100 is configured to support the necessary programming for collecting converting and storing the medical data of users 102, supporting communications with medical data providers, organization of data by users 102, and uploading of medical data to the devices 10 of users 102. The process of obtaining organizing and uploading medical data to the devices 10 of users 102 is explained in more detail below.

In one embodiment, system 100 employs a medical information interface module 106 for obtaining medical records from a variety of sources. In one arrangement, where a user's 102 medical data is stored electronically at either a doctor's office or medical records storage facility, it is contemplated that medical interface module 106 may obtain the records electronically via web based communications. Alternatively, if user 102 only has medical records that are stored on paper, medical interface module 106 is contemplated as live personnel facility that sends paper requests (mail, facsimile etc. . . . ) to the doctors of user 102 and receives, scans and returns the same paper documents.

As illustrated in FIG. 2, system 100 advantageously, maintains a translation module 107 which converts the electronically obtained and scanned paper medical records of a user 102, obtained by medical interface module 106, into a single format for processing and storage by system 100.

Database 108 is provided for storage of incoming medical records from medical record interface 106 and personal data from user interface 103. Additionally, database 108 maintains the necessary records for organization of the stored medical data of user 102 by processor module 104 until and after there are uploaded to device 10.

It is understood that although FIG. 2 shows database 108 as a single module within system 100, it is understood that any typical arrangement for databases may be employed including multiple redundant drives as well as offsite and 3^{rd} party storage.

Furthermore, FIG. 2 is intended to be illustrative of the exemplary modules of a medical storage system 100 and is in no way intended to limit the scope of the invention. Additional modules may be added, or existing modules ay be combined as desired as known in the computer industry to support the salient features of the present invention as the operational flow diagram set forth below.

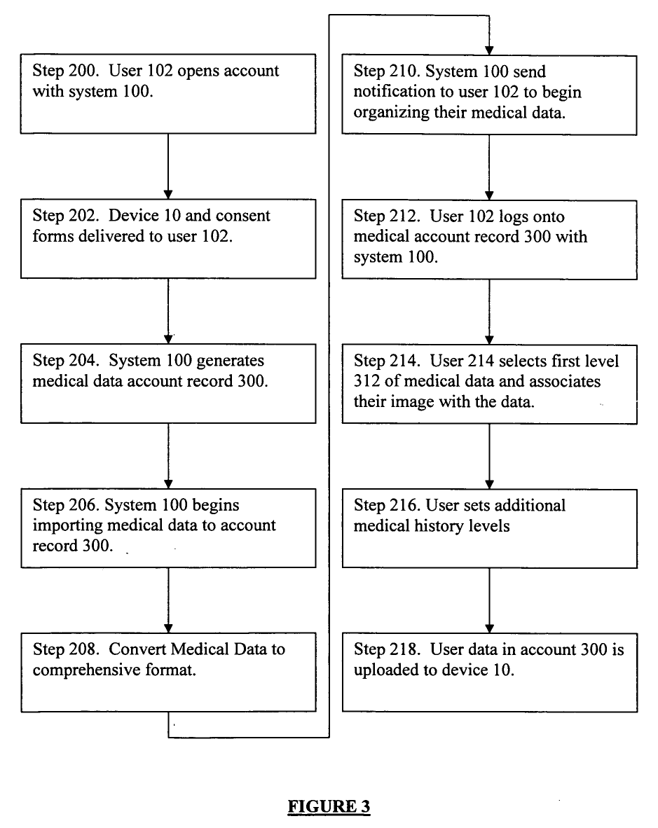

Turning to the operation of medical data storage system 100, FIG. 3 is an exemplary flow chart that shows the steps for: user 102 to set up an account, system 100 to obtain their medical records; user 102 to organize their records; and system 100 to upload their records to their portable device 100. It is understood that the flow chart of FIG. 3 is intended as an example and steps separated into sub-steps or combined with one another are also within the contemplation of the present invention.

In step 200, user 102 contacts system 100, the communication being received at user interface 103. For the purposes of illustration, user 102 is discussed throughout as a web user 102, but the various steps, when possible, apply to telephone users 102 as well.

At step 202, user 102 requests a new account and a device 10. In one arrangement, system 100 provides user 102 with a device by mail, but it is possible that users 102 may employ their own existing portable storage devices if desired. For example, in a preferred arrangement, a package is sent to user 102 including device 10, security envelopes, bar code stickers and medical record release consent forms. In another arrangement, consent forms and other medical release forms may be sent electronically.

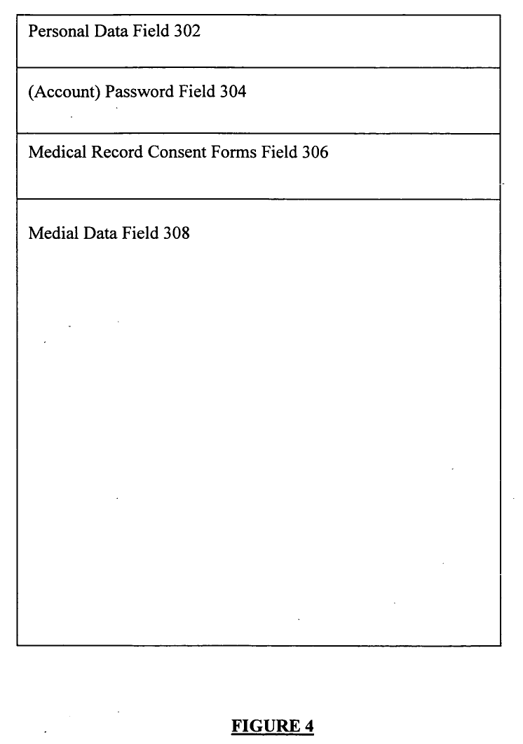

At step 204, system 100 generates the user's account 300 and receives their password, medical record authorizations (consent forms), contact and billing information as well as a digital photo of the user to associate with account 300. FIG. 4 shows an exemplary user account records 300 with exemplary personal information field 302, account password field 304, consent form field 306 and medical data field 308. Additional fields may be added if necessary. Account record 300 is stored in database 108 for future access and organization.

Once payment has been arranged, using the medical records authorizations from user 102, at step 206 medical records interface 106 begins to retrieve the medical records of user 102 from the doctors and locations identified by user 102. This medical data is stored in medical data field 308 of user account record 300 as shown in FIG. 4. As noted above, such records may be obtained electronically, by mail (and scanned) or they may be obtained (in either format) directly from user 102 if there are in possession of their own records. It is contemplated that user 102 may have arrangements with their physicians that records from each visit are contemporaneously scanned and delivered to system 100 as soon as they are generated in order to keep medical account 300 up to date.

It is noted that medical data, obtained in step 206 may include but is not limited to; contact information such as next-of-kin or emergency contacts; basic medical history; medication history; specialist visit and consultation details; current prescription use—routine prescribed RX record; over-the-counter (OTC)—medication record, OTC record; personal/medical information (such as health insurance number, Medicare number, etc.); medical diagnostic and testing records (blood tests, cardiograms, EEGs etc.); medical imaging results (X-Ray images, CAT scans etc.); information captured from home medical monitoring devices (such as glucometers and blood pressure meters); legal information such as living wills; allergies/reactions; summary of health tests & preventive health screenings; summary of medications; family history; social history; quick reference (PCP, Specialist, Dentist, Hospital Information, Pharmacy Information, Health Insurance Information, Secondary Insurance Information, Other Insurance, Dental Insurance, Primary Caregiver, Emergency Contact #1, Clergy); surgeries/injuries/procedures; ongoing diagnostic monitoring data; and immunization records.

At step 208, conversion module 107 converts all of the medical records from user 102 into a single format. Such format may be an existing popular format such as .pdf (Adobe ™), a proprietary format (readable in a common .txt or .html reader), or some combination of the two. As the medical record data is collected and converted, system 100 stores this data to database 108 in medical data field 208 of the corresponding user account 300.

Once the medical data collection process is completed, or otherwise reaches some pre-defined stopping point (such as user 102 set point at which they would like to begin working on the record organization), at step 210 processor 104 indicates to user interface 103 to send user 102 a notification, such as an e-mail to text message notifying them that their medical history is now stored and ready for organization.

Next, at step 212, user 102 logs onto system 100, enters their password and opens their account record 300 for organization. At this stage user 102 is presented with many options regarding their organization and security of their various medical records stored in medical record field 308.

It is contemplated at step 214 that user 102 selects (or is prompted with a pre-formatted form) a set of first level basic emergency medical information 312 which may include, age, weigh, height, blood type, allergies, and other such vital information that may be useful to first responders. In one arrangement, system 100 may actually pre-populate such a first level of medical data and simply ask the user to confirm or modify the information.

In one embodiment, the digital photo of user 102, supplied earlier, may be associated with this first level 312 of data so that it may act as an identifier to emergency medical personnel without having a name or other undesirable personal information being used instead.

It is contemplated that this first layer of information 312 is otherwise accessible to anyone who obtains device 10, without any password so that it may be quickly accessed by emergency personnel, even if user 102 is unconscious.

After the first level of data is organized, at step 216, user 102 then begins organizing their more personal and detailed medical history into one or more additional levels of access 314, 316 . . . , each of which may be associated with one or more additional passwords (not the same as the user's account password). If device 10 supports such a feature, it is contemplated that the passwords for the various levels of data may be biometric such as fingerprint scans.

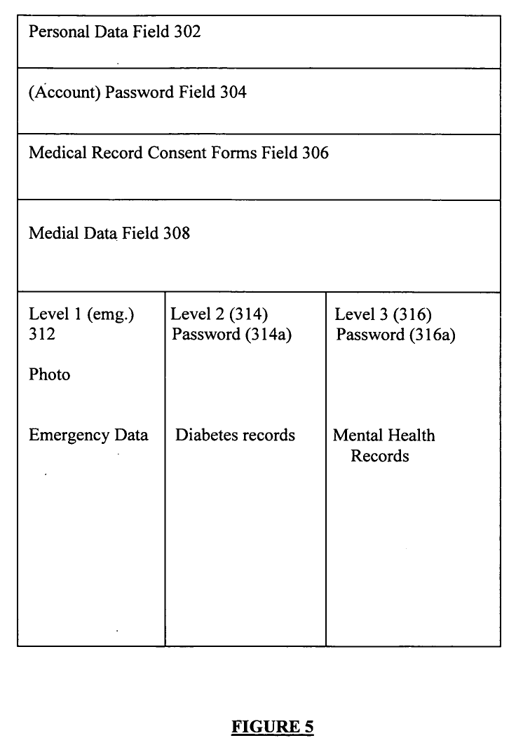

For example, if a user has a detailed diabetes medical history and a detailed medical history for a separate mental disorder, they may desire to set the diabetes history in one level 314 with one password 314(a) and the mental history in a separate level 316 with another password 316(a). It is understood that there are nearly limitless combinations of such organization all of which are contemplated by the present invention. Furthermore, it is understood that overlapping passwords may be used so that one or more levels 314, 316, . . . may be covered by a single password. FIG. 5 is an exemplary account record 300 showing the basic fields as illustrated in FIG. 4 as well as the additional data in the various levels of access.

After the completion of the organization of user's 102 medical data in the various levels, at step 218 user 102 signals to system 100 that they are prepared to have there medical account 300 uploaded to their device 10. In one arrangement, user 102 simply places device 10 into a USB connection port on their home computer and presses an upload button which directs processor 104 and user interface module 103 to retrieve account 300 from database 108 and deliver it to device 10 for storage. In an alternative arrangement, if user 102 is without the electronic means to insert their device 10, they may physically mail it to system 10 for upload by system 100 employees.

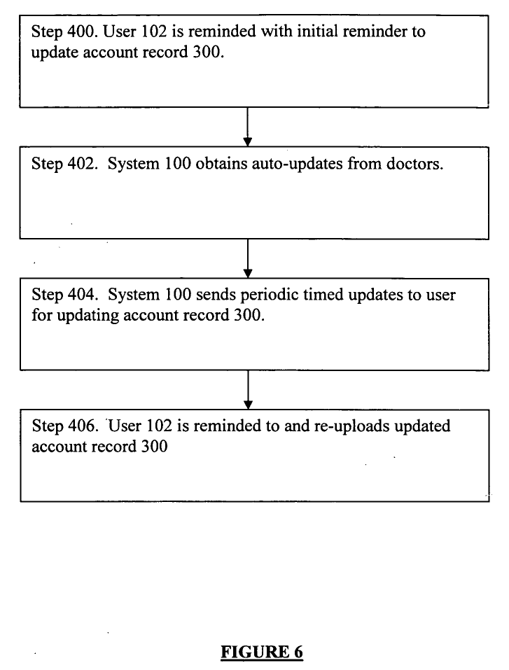

In another embodiment of the present invention, as illustrated in flow chart FIG. 6, after completion of the organization of medical data in field 308 and the storage of such data into device 300, at step 400, user is reminded by system 100 to inform doctors to provide update records on a periodic basis to system 100, after the initial transfer, in order to keep record 300 up to date.

At step 402, system 100 may, if electronically, connected to medical records facilities or electronic records at a doctors office, may directly provide update requests so that user 102 does not need to make the request on their own.

At step 404, after a predetermined amount of time, system 100 sends an additional reminder to user 102. For example, system 100 may be set to send update reminders to user 102 every six months. It is further contemplated that user 102 may log onto their account 300 and set the reminder time shorter or longer depending on their personal needs (eg. more frequent doctor visits may require more frequent update reminders).

At step 406, after a predetermined amount of time, system 100 sends a re-upload notification to user 102. For example, system 100 may be set to send a re-upload request to user 102 every three months, whereby user 10 is instructed to re-insert their device 10 into their computer to match step. It is further contemplated that user 102 may log onto their account 300 and set the re-update time shorter or longer depending on their personal needs or even request an immediate re-update in the event of the passing of a medical event, such as a major surgery.

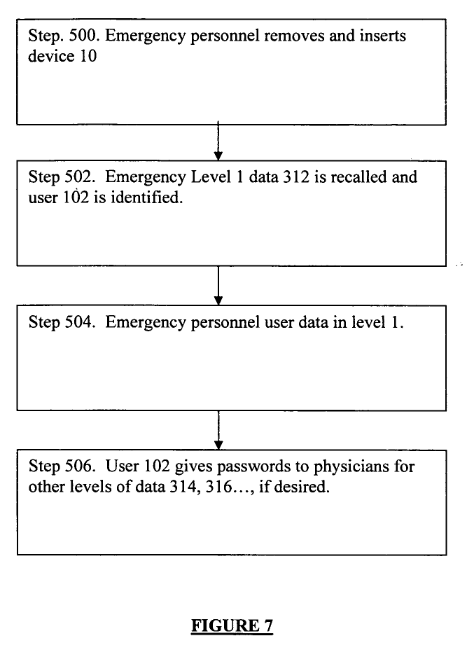

Turning now to a sample operation of device 10, the flow chart of FIG. 7 shows the steps following an emergency incident, such as a car accident. It is assumed that user 102 is either unconscious or otherwise incapacitated.

At step 500, emergency medical personnel that arrive at the scene of the incident, removed device 10 and insert it into a portable computer device, either hand held or a lap top in the ambulance or other service vehicle.

At step 502, device 10 immediately allows access to the emergency medical data in level 1 (312) from medical data field 308 of user's 102 account record 300. It is contemplated that the stored data is in a readily readable format such as HTML (readable by any browser program) or .pdf (readable with a standard plug in reader).

At step 504, a picture of user 102, stored in the level 1 data 312 is show to the emergency personal for identification that device 10 and the records contained therein belong to the person in front of them being treated. It is contemplated that such a feature not only provides security in that stolen devices 10 are not traceable to the other personal data (ID numbers, etc. . . . ) of user 102, but also devices 10 that are separated from users in larger accidents or even natural disasters may be associated with the appropriate patient (user 102). Once retrieved, medical personnel may use the information from medical level 1 (312) as need, such as to prevent allergic reactions to emergency medications, to match blood types for emergency transfusions, etc.

At step 506, once user 102 is stabilized and is being treated by attending physicians, user 102 (or a relative with authority and the passwords) may begin to provide higher level stored medical records to doctors on a need to know basis. For example, if the medical emergency was from a diabetic shock, user 102 may provide an attending physician at the hospital with password 314(a) regarding their level two diabetic medical history 314 as shown in FIG. 5.

It is understood that the emergency scenario provided of an emergency is only one use for device 10 and the above described process. It is understood that regular medical record storage and non-emergency uses are also within the contemplation of the present invention.

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A method for uploading of a user's medical data to a portable device said method comprising the steps of:
receiving a request for storage of medical data to a portable device;
collecting medical data from a plurality of sources;
converting data to a uniform format for storage on said portable device;
receiving at least one user input relating to the organization of said medical data into at least one first emergency layer of data representing a first category of information and at least one second secured layer of data representing a second category of information, said first and second layers of data being an organized medical data; and
generating a communication to said user for uploading said organized medical data to said portable device.

2. The method as claimed in claim 1, wherein said request for storage of medical data is received via an internet communication.

3. The method as claimed in claim 1, wherein said portable device is a wearable digital data storage device.

4. The method as claimed in claim 1, wherein said portable device is provided by a medical data storage system.

5. The method as claimed in claim 1, wherein said medical data is collected from a plurality of said user's doctors, in either one of electronic form paper form.

6. The method as claimed in claim 5, wherein said medical data in electronic form is automatically transmitted on a periodic basis.

7. The method as claimed in claim 1, wherein said conversion step converts said medical data to a single format.

8. The method as claimed in claim 1, wherein said medical data is stored in a medical data storage system.

9. The method as claimed in claim 8, wherein said organization of said medical data is performed in part by said medical data storage system.

10. The method as claimed in claim 8, wherein said organization of said medical data is performed in part by said user via said medical data storage system.

11. The method as claimed in claim 1, wherein said first emergency layer of data representing a first category of information includes a digital photo of said user.

12. The method as claimed in claim 11, wherein said digital photo of said user is the only personal identity information in said first emergency layer of data representing a first category of information includes a digital photo of said user.

13. The method as claimed in claim 11, wherein said first emergency layer of data representing a first category of information includes information directed to emergency medical personnel.

14. The method as claimed in claim 11, wherein said second secured layer of data representing a second category of information includes additional medical records of said user under security protection.

15. The method as claimed in claim 14, wherein said security protection is a biometric security measure.

16. The method as claimed in claim 1, further comprising, at least a third secured layer of data representing a third category of information.

17. The method as claimed in claim 1, further comprising the step of prompting said user to provide updated medical records.

18. The method as claimed in claim 1, further comprising the step of prompting either a doctor or a medical data records storage facility to provide updated medical records.

19. The method as claimed in claim 17, wherein said prompts are automatically provided on a periodic basis.

20. The method as claimed in claim 18, wherein said prompts are automatically provided on a periodic basis.
